(19) United States
(12) Patent Application Publication
(10) Pub. No.: US 2002/0069375 A1
(43) Pub. Date: Jun. 6, 2002

(54) System, method, and article of manufacture for data transfer across clock domains

(76) Inventor: Matt Bowen, Littlemore (GB)

Correspondence Address: CARLTON FIELDS, PA, P.O. BOX 3239, TAMPA, FL, 33601-3239, US

(21) Appl. No.: 09/772,521

(22) Filed: Jan. 29, 2001

Related U.S. Application Data
(63) Continuation-in-part of application No. 09/687,419, filed on Oct. 12, 2000.

(51) Int. Cl. G06F 1/12

(52) U.S. Cl. 713/400

(57) ABSTRACT

A system, method and article of manufacture are provided for data transfer across different clock domains. A request for transferring data from a sending (transmitting) process in a first domain to a receiving process in a second domain is received. The first domain and the second domain have different clocks. A channel circuit is created with handshaking and resynchronization logic to help resolve metastability. The channel circuit is then used to transfer the data from the sending process to the receiving process.

### RELATED APPLICATIONS

This application is a continuation in part of U.S. patent application entitled System, Method, and Article of Manufacture for Guaranteed Data Transfer Across Clock Domains, Ser. No. 09/687,419 filed Oct. 12, 2000 and assigned to common assignee, and which is incorporated herein by reference for all purposes.

### FIELD OF THE INVENTION

The present invention relates to data transfer and more particularly to transferring data across differing clock domains.

### BACKGROUND OF THE INVENTION

When coupling two external devices together, such as a digital computer and an input/output device, it may not be possible or advantageous for all the logic circuitry involved to derive its clock source from the same clock. In such a case, a plurality of clocks, each providing a clock signal to an exclusive region of the logic circuitry of a device, or each providing a clock signal to the logic circuitry of separate, external, devices may be employed. Thus, in such circumstances, multiple clock domains may exist. Components of a synchronous logic circuit which derive their clock source from the same clock are in the same clock domain. In contrast, components of synchronous logic circuits, or synchronous logic circuits, which derive their clock source from different, independent clocks are in different clock domains.

Signals transferred between a first synchronous logic circuit in a first clock domain and a second synchronous logic circuit in a second clock domains are transferred asynchronously. The problem inherent in such a transfer is that a signal transferred from the first synchronous logic circuit may be in transition at the same time a clock signal for the second synchronous logic circuit triggers the memory element receiving as input the signal from the first synchronous logic circuit, thereby inducing metastability. In the prior art, to prevent an asynchronous signal arriving at the second logic circuit from being in transition during triggering of the second logic circuit, the first and second circuits use control signals in the form of a two-way handshake to synchronize the asynchronously transferred signal.

Another problem common in the prior art is that a request for data stored in a cache in an asynchronous clock domain can miss, or more specifically an application can go to fetch something from the cache and it isn't there. When performed across clock boundaries, this can lead to loss of data, lags in performance, and system lockups.

Further, different processes in a program may be assigned to different clock domains. This means that each hardware clock will be connected to all the hardware in that clock domain. The transfer of data between domains with different clocks is problematic, due to the asynchronous nature of the communication. In particular a problem known as metastability manifests itself This is described in the standard textbooks.

There is thus a need for enabling reliable transfer of data across clock domains.

### SUMMARY OF THE INVENTION

A system, method and article of manufacture are provided for data transfer across different clock domains. A request for transferring data from a sending (transmitting) process in a first domain to a receiving process in a second domain is received. The first domain and the second domain have different clocks, where “different clocks” is not limited to mean only completely different clocks, but rather can include operation/execution at different clock speeds, etc. A channel circuit is created with handshaking and resynchronization logic to help resolve metastability. The channel circuit is then used to transfer the data from the sending process to the receiving process.

In one embodiment of the present invention, multiple sending processes send data along the same channel circuit. Further, multiple receiving processes can receive data along the same channel circuit. In a preferred embodiment of the present invention, the channel circuit is built with four-phase handshaking.

In an embodiment of the present invention, the data at the first domain is assigned to a variable at the second domain. In another embodiment of the present invention, the channel circuit includes a controller and a data path, where the controller tells the data path when to store a variable in a storage medium associated with the receiving process that is being sent by the sending process.

### BRIEF DESCRIPTION OF THE DRAWINGS

The invention will be better understood when consideration is given to the following detailed description thereof. Such description makes reference to the annexed drawings wherein:

FIG. 1 is a schematic diagram of a hardware implementation of one embodiment of the present invention;

FIG. 2 is a flow diagram illustrating a process for data transfer across domains having different clocks;

FIG. 3 is a circuit diagram of an implementation of a channel with two-phase handshaking;

FIG. 4 is a circuit diagram of a channel between different clock domains, with four-phase handshaking and metastability-resolvers; and

FIG. 5 is a flow diagram of a process for transferring data across clock domains according to an embodiment of the present invention.

### DETAILED DESCRIPTION OF THE PREFERRED EMBODIMENTS

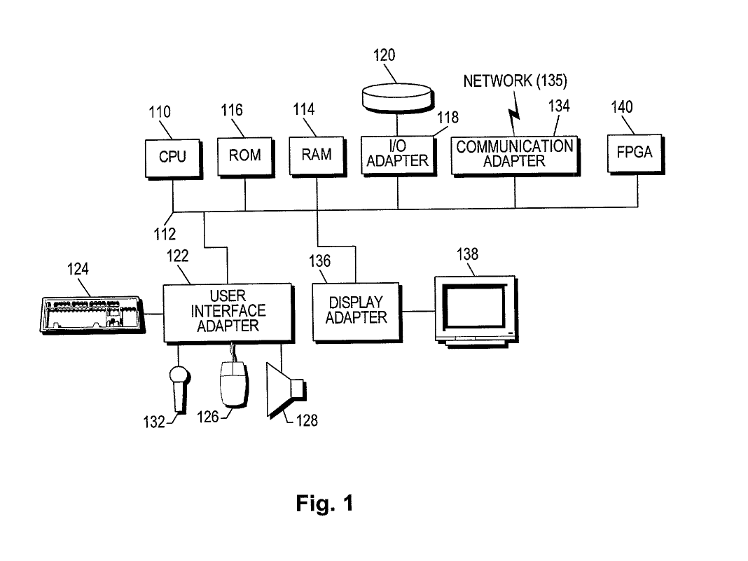

A preferred embodiment of a system in accordance with the present invention is preferably practiced in the context of a personal computer such as an IBM compatible personal computer, Apple Macintosh computer or UNIX based workstation. A representative hardware environment is depicted in FIG. 1, which illustrates a typical hardware configuration of a workstation in accordance with a preferred embodiment having a central processing unit 110, such as a microprocessor, and a number of other units interconnected via a system bus 112. The workstation shown in FIG. 1 includes a Random Access Memory (RAM) 114, Read Only Memory (ROM) 116, an I/O adapter 118 for connecting peripheral devices such as disk storage units 120 to the bus 112, a user interface adapter 122 for connecting a keyboard 124, a mouse 126, a speaker 128, a microphone 132, and/or other user interface devices such as a touch screen (not shown) to the bus 112, communication adapter 134 for connecting the workstation to a communication network (e.g., a data processing network) and a display adapter 136 for connecting the bus 112 to a display device 138. The workstation also includes a Field Programmable Gate Array (FPGA) 140 with a complete or a portion of an operating system thereon such as the Microsoft Windows NT or Windows/98 Operating System (OS), the IBM OS/2 operating system, the MAC OS, or UNIX operating system. Those skilled in the art will appreciate that the present invention may also be implemented on platforms and operating systems other than those mentioned.

A preferred embodiment is written using JAVA, C, and the C++ language and utilizes object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. A preferred embodiment of the invention utilizes HyperText Markup Language (HTML) to implement documents on the Internet together with a general-purpose secure communication protocol for a transport medium between the client and the Newco. HTTP or other protocols could be readily substituted for HTML without undue experimentation. Information on these products is available in T. Berners-Lee, D. Connoly, “RFC 1866: Hypertext Markup Language—2.0” (November 1995); and R. Fielding, H, Frystyk, T. Berners-Lee, J. Gettys and J. C. Mogul, “Hypertext Transfer Protocol—HTTP/1.1: HTTP Working Group Internet Draft” (May 2, 1996).

HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystem's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

Another technology that provides similar function to JAVA is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for JAVA without undue experimentation to practice the invention.

C is a widely used programming language described in “The C Programming Language”, Brian Kernighan and Dennis Ritchie, Prentice Hall 1988. Standard techniques exist for the compilation of C into processor instructions such as “Compilers: Principles, Techniques and Tools”, Aho, Sethi and Ullman, Addison Wesley 1998, and “Advanced Compiler Design and Implementation”, Steven Muchnik, Morgan Kauffman 1997, which are herein incorporated by reference.

Handel was a programming language designed for compilation into custom synchronous hardware, which was first described in “Compiling occam into FPGAs”, Ian Page and Wayne Luk in “FPGAs” Eds. Will Moore and Wayne Luk, pp 271-283, Abingdon EE & CS Books, 1991, which are herein incorporated by reference. Handel was later given a C-like syntax (described in “Advanced Silicon Prototyping in a Reconfigurable Environment”, M. Aubury, I. Page, D. Plunkett, M. Sauer and J. Saul, Proceedings of WoTUG 98, 1998, which is also incorporated by reference), to produce various versions of Handel-C.

Handel-C is a programming language marketed by Celoxica Limited, 7-8 Milton Park, Abingdon, Oxfordshire, OX14 4RT, United Kingdom. It enables a software or hardware engineer to target directly FPGAs (Field Programmable Gate Array) in a similar fashion to classical microprocessor cross-compiler development tools, without recourse to a Hardware Description Language. Thereby allowing the designer to directly realize the raw real-time computing capability of the FPGA.

Handel-C is a programming language designed to enable the compilation of programs into synchronous hardware; it is aimed at compiling high level algorithms directly into gate level hardware.

The Handel-C syntax is based on that of conventional C so programmers familiar with conventional C will recognize almost all the constructs in the Handel-C language.

Sequential programs can be written in Handel-C just as in conventional C but to gain the most benefit in performance from the target hardware its inherent parallelism must be exploited.

Handel-C includes parallel constructs that provide the means for the programmer to exploit this benefit in his applications. The compiler compiles and optimizes Handel-C source code into a file suitable for simulation or a netlist which can be placed and routed on a real FPGA.

### Data Transfer Across Clock Domains

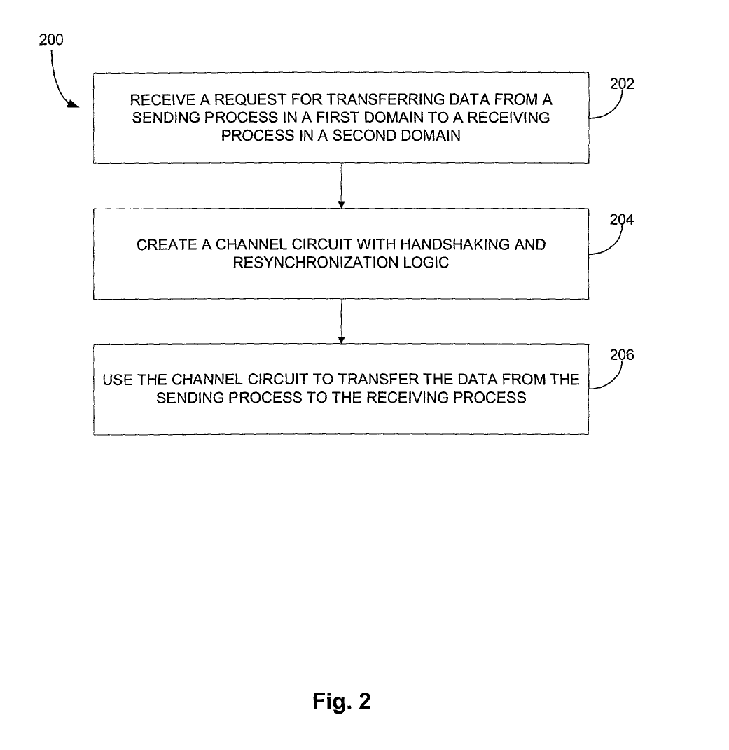

FIG. 2 illustrates a process 200 for data transfer across different clock domains. In operation 202, a request for transferring data from a sending (transmitting) process in a first domain to a receiving process in a second domain is received. The first domain and the second domain have different clocks. Note that the term “different clocks” is not limited to mean only completely different clocks, but rather can include operation/execution at different clock speeds, etc. In operation 204, a channel circuit is created with handshaking and resynchronization logic to help resolve metastability. The channel circuit is then used to transfer the data from the sending process to the receiving process in operation 206.

Handel-C consists of a number of parallel processes that can communicate using channels. A number of transmitting processes may send data along the same channel, and a number of receiving processes may receive data along the same channel. However, only one send/receive pair of processes may be active at any one time. When a process comes to a channel communication it waits until a process at the other end of the channel is ready to communicate, and then the data at the transmitting end of the channel is assigned to the variable at the receiving end of the channel.

Different processes in the program may be assigned to different clock domains. This means that each hardware clock will be connected to all the hardware in that clock domain. The transfer of data between domains with different clocks is problematic, due to the asynchronous nature of the communication. In particular a problem known as metastability manifests itself. This is described in the standard textbooks.

The Handel-C compiler translates software constructs into hardware circuits. These consist of a controller and a data path. The important part of the invention described here is the control circuit. This tells the data path when to store a variable in the receiving process that is being sent by the transmitting process. This variable may be stored in any appropriate hardware device, such as a register or a RAM.

When the compiler comes to a channel it uses the following algorithm:

Do all of the processes connected to the channel share the same clock domain?

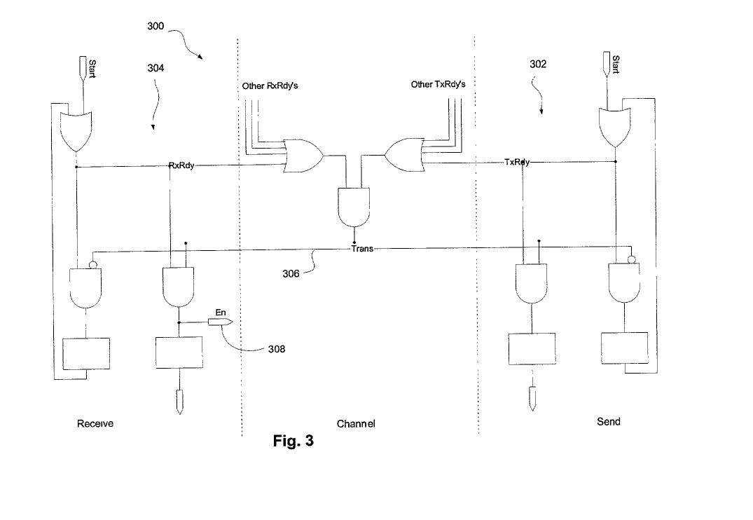

1. Yes. The circuit 300 shown in FIG. 3 is used to control the channel communication.

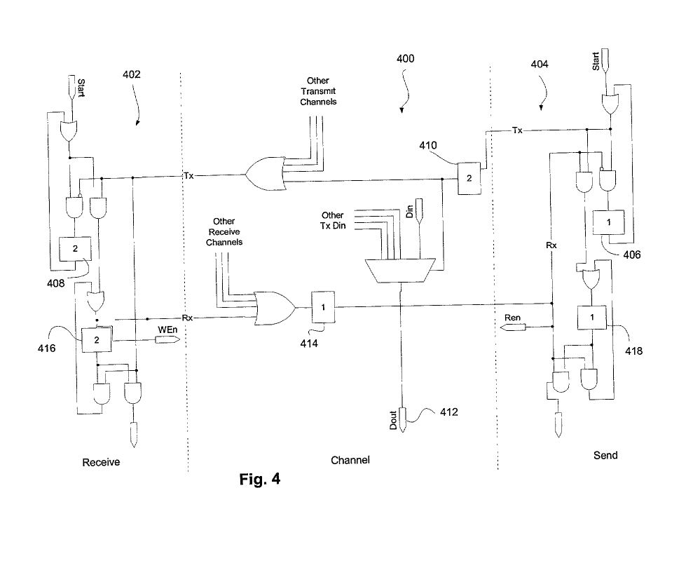

2. No. The circuit 400 shown in FIG. 4 is used to control the communication.

The circuit shown in FIG. 3 works as follows: When the process is ready to communicate a token (pulse) arrives at the wire (or line) 302 (labeled ‘Start’). The diagram shows two processes 302, 304 that may be ready to communicate, together with connections to other sending and receiving processes (labelled ‘RxRdy’ and ‘TxRdy’). When the two processes are ready the wire 306 (marked ‘Trans’) goes high, causing the wire 308 (marked ‘En’) to go high. This is the wire that enables the storage device (not shown) to store the transmitted variable. The other circuitry is used to reset the flip-flop used to store the incoming token, and to pass the token on to the circuitry that is to be used after the channel communication is complete.

The circuit shown in FIG. 4 again shows two processes 402, 404 ready to communicate. However, these are processes in different clock domains, and so this circuitry uses four-phase handshaking and metastability-resolvers. Note the labeling on the flip-flops 406, 408 showing the use of clocks ‘1’ (in the transmitting process) and ‘2’ (in the receiving process). When the transmitting process is ready the ‘Tx’ pulse is clocked through a flip-flop 410 using the receiving circuit's clock. This signal passes to the receiving process, and is also used to multiplex the correct data to the receiving process, on bus ‘Dout’ 412. When the receiving process is also ready the signal ‘WEn’ is asserted to enable writing to the appropriate storage device (not shown), and the signal ‘Rx’ is asserted to tell the transmitting process that the communication is taking place. Signal ‘Rx’ is passed through a flip-flop 414 clocked by the transmitting circuit's clock. The incoming receiving circuit's token is passed to a second flip-flop 416, which is only reset when the ‘Tx’ signal goes low. The ‘Rx’ signal is used to enable reading from the transmitting circuit's storage device, and then to reset the second flip-flop 418 in the transmit circuit when the communication is complete.

More illustrative embodiments of the present invention are provided in the following section.

### Reliable Data Transfer Across Clock Domains

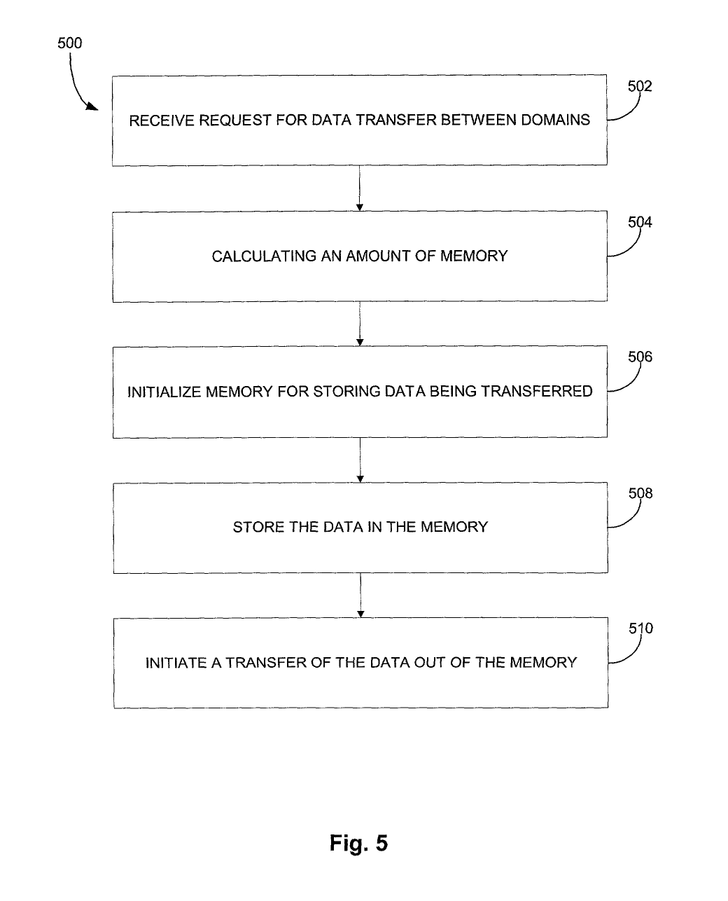

FIG. 5 depicts a process 500 for reliably transferring data across clock domains. In operation 502, a request for data transfer from a first domain to a second domain is received. The first and second domains may or may not have different clock speeds. An amount of the memory required to store some or all of the data is calculated in operation 504. A memory for storing some or all of the data from the first domain is initiated in operation 506. Such memory can be a cache, a buffer, RAM, reconfigurable (reprogrammable) logic, etc.

A cache is a place to store something more or less temporarily. Computers include caches at several levels of operation, including cache memory and a disk cache.

There are several types of caches:

Local server caches (for example, corporate LAN servers or access provider servers that cache frequently accessed files). This is similar to the previous idea, except that the decision of what data to cache may be entirely local.

A disk cache (either a reserved area of RAM or a special hard disk cache) where a copy of the requested data and adjacent (most likely to be accessed) data is stored for fast access.

RAM itself, which can be viewed as a cache for data that is loaded in from the first domain (or other I/O storage systems).

L2 cache memory, which is on a separate chip from the microprocessor but faster to access than regular RAM.

L1 cache memory on the same chip as the microprocessor.

A buffer is a data area shared by hardware devices or program processes that operate at different speeds or with different sets of priorities. The buffer allows each device or process to operate without being held up by the other. In order for a buffer to be effective, the size of the buffer and the algorithms for moving data into and out of the buffer need to be considered by the buffer designer under the precepts set forth herein.

Referring again to FIG. 5, in operation 508, the data is stored in the memory. A transfer of the data from the memory to the second domain is initiated in operation 510 upon determining that a predetermined number of fetches are required to transfer the data stored in the memory.

In an illustrative scenario, suppose an application wishes to fetch data from a cache. The present invention does not allow for a “miss,” i.e., does not allow the application to attempt to fetch data from the cache that isn't there. Rather, the application will only be allowed to fetch the data (or the data will only be sent to the application) when there is an acceptable amount of data in the cache. (What an acceptable amount of data is can be determined on a case-by-case basis. One example would be enough data for one fetching by the application.) It is known that the requisite amount of data has been stored in the cache because the size needed for the cache has been precalculated, and the first fetch is not initiated until there is at least enough data to provide N number of fetches.

In one embodiment of the present invention, the calculation of the amount of memory required is at least partially based on the clock speeds of the first and second domains. The calculation of the amount of memory required can also be partially based on data known prior to calculation vis a vis required amount of the memory. Preferably, the data transfer to and from the memory is primarily first in first out (FIFO).

In another embodiment of the present invention, a circuit is created in reconfigurable logic to perform the various steps set forth above. In a preferred embodiment, the circuit is created utilizing a Field Programmable Gate Array (FPGA). In other words, an FPGA is programmed to perform the operations set forth in the discussion of FIG. 5.

In a preferred embodiment, the circuit includes four-phase handshaking with resynchronization logic to help resolve metastability, as set forth above. As stated above, the present invention applied in conjunction with the Handel-C programming language can support data transfer between domains with different clocks. A channel is used where each end is clocked by a different clock. The compiler is programmed to detect that a different clock is being used for the send and receive and to build four phase handshaking with resynchronization logic to resolve metastability. Preferably, a sample data rate conversion is performed as the data passes between the clock domains.

In an illustrative scenario in which the present invention may be implemented, clients and a server are implemented as independent pieces of hardware, communicating via channels. The server reads an array of channels from the client and puts the results in a queue as they arrive. They are read from the queue by a dummy service routine, where the client requests would be processed.

The server clock runs at half the speed of the client clock to allow time for complex assignments during request processing.

There is a pair of identical client functions. These functions merely select valid requests from an array and send them to the server.

The internal queue is implemented in a structure consisting of two counters (queueIn and queueOut) which are used to test how full the queue is, and an mpram containing the queued data. Use of an mpram allows the queue to be written to and read from in the same clock cycle. The associated code in the HandelC programming language is:

typedef struct
{

unsigned int queueIn;
unsigned int queueOut;
mpram
{

wom int DataWidth in[MaxQueue];
rom int DataWidth out[MaxQueue];

} values;

} Queue;

According to another embodiment, the present invention provides an electronic system which includes a first system which operates in response to a first clock signal and a second system which operates in response to a second clock signal, the first clock signal being asynchronous with respect to the second clock signal. A direction control circuit is connected between the first and second systems. The direction control circuit determines whether data transfer between the first and second systems is to occur in a first direction from the first system to the second system, or in a second direction from the second system to the first system. The direction control circuit provides one or more direction control signals which are representative of the direction of data transfer. Data transfer proceeds through a single dual-port memory having a write port and a read port.

A write control circuit is coupled to the first system, the second system and the direction control circuit. The write control circuit receives at least one of the direction control signals from the direction control circuit. When the direction control signals are representative of the first direction of data transfer, the write control circuit couples the first system to the write port of the dual-port memory. Conversely, when the direction control signals are representative of the second direction of data transfer, the write control circuit couples the second system to the write port of the dual-port memory.

A read control circuit is coupled to the first system, the second system and the direction control circuit. The read control circuit receives at least one of the direction control signals from the direction control circuit. When the direction control signals are representative of the first direction of data transfer, the read control circuit couples the second system to the read port of the dual-port memory. Conversely, when the direction control signals are representative of the second direction of data transfer, the read control circuit couples the first system to the read port of the dual-port memory.

In the foregoing manner, bi-directional data transfer between the first and second systems is enabled using a single dual-port memory. Because only one dual-port memory is required, the layout area of the electronic system is advantageously reduced when compared with prior art systems.

The first and second systems can include various computer-based systems. In one embodiment, the first system includes a central processing unit (CPU). This CPU can be included in the same integrated circuit as the direction control circuit, the write control circuit, the read control circuit and the dual-port memory. The second system can be, for example, a PCI-based system. In such an embodiment, the integrated circuit which includes the CPU can be easily connected to various PCI-based systems.

The present invention further includes a method of providing bi-directional data transfer between a first system which operates in response to a first clock signal and a second system which operates in response to a second clock signal, wherein the first clock signal is asynchronous with respect to the second clock signal. This method includes the steps of: (1) determining a direction of data transfer between the first and second systems, the direction of data transfer being either a first direction from the first system to the second system, or a second direction from the second system to the first system, (2) generating one or more direction control signals representative of the direction of data transfer, (3) coupling the first system to a write port of a dual-port memory when the direction control signals are representative of the first direction of data transfer, (4) coupling the second system to a read port of the dual-port memory when the direction control signals are representative of the first direction of data transfer, (5) coupling the second system to the write port of the dual-port memory when the direction control signals are representative of the second direction of data transfer, and (6) coupling the first system to the read port of the dual-port memory when the direction control signals are representative of the second direction of data transfer.

One embodiment of the present invention is utilized for data transfer between integrated circuits. Integrated circuits are groups of transistors employed on a single monolithic substrate. The groups of transistors embody various functions for a system (for example, a computer system). One particular example of an integrated circuit is a superscalar microprocessor which embodies multiple instruction processing pipelines. Integrated circuits typically have a clock input associated with them, which defines a “clock cycle”. A clock cycle is an interval of time in which the functions embodied on the integrated circuit complete a portion of their tasks (a “subfunction”). At the end of a clock cycle, the results are moved to the next function or subfunction which operates on the value.

Integrated circuits may employ arrays for storing information useful to the embodied functions. For example, data and instruction caches are arrays that are commonly employed within superscalar microprocessors. As used herein, the term “array” means a plurity of storage locations configured into a structure from which the values stored in one or more of the plurality of storage locations may be selected for manipulation. Arrays are configured with one or more input ports which allow functions to access information stored in the array. Each input port may be associated with an output port. A particular input port may allow read access, write access, or read/write access to storage locations within the array and is referred to as a read port, a write port, or a read/write port, respectively. A read access is an access in which the value in the selected storage location is transferred to the associated output port and the storage location is left unchanged. A write access is an access in which the value in the selected storage location is changed to a value provided with the input port. A port which allows read/write access allows either a read or a write access to occur. Ports which allow write accesses typically are associated with a write data input port. The write data input port conveys the data to be stored at the address provided on the write port.

“Indexes” are often used to select a storage location within an array. An index is a value which indicates which of the plurality of storage locations of an array that a particular access intends to manipulate. The act of selecting one of a plurality of storage locations according to an index is called “indexing”. In one particular example, a set associative cache has an index which identifies which group of sets to access and a “way value” which selects one of the sets within the selected group for manipulation.

In many cases, more than one access to an array in a given clock cycle may be desirable for the functions an integrated circuit embodies. An array which allows two accesses per clock cycle is referred to as “dual-ported”. Each port may allow a read access, a write access, or a read/write access. Unfortunately, dual-ported arrays are much larger than single ported arrays, often occupying more than double the silicon area of a single ported array which stores the same amount of information.

One particularly useful dual-ported array is an array in which one port allows a read access while a second (write) port updates a storage location with new information. Arrays that are configured in this way do not block a read access with an update, which simplifies array control logic and may improve performance. An example of an array configured with a read port and a write port for updates is a branch prediction array associated with a branch prediction unit of a superscalar microprocessor. The branch prediction array stores information related to past branch predictions. A fetch address is used to index into the branch prediction array, and the information read from the array is used to create a branch prediction associated with the instructions residing at the fetch address. When a branch instruction is mispredicted, then the correct address is fetched and new prediction information is calculated. The new prediction information should be stored into the branch prediction array in a storage location indexed by the address of the mispredicted branch instruction. Then, the next time the branch instruction is fetched, a correct prediction may be made. The new prediction information is available to update the branch prediction array in the clock cycle following the cycle in which the correct address is fetched and also to predict the amount of data being transferred to help determine the size of memory required.

Accordingly, an embodiment of the present invention includes an integrated circuit employing an update unit for an array. The update unit delays the update of the array until a clock cycle in which the functional input to the array is idle. The input port normally used by the functional input is then used to perform the update. During clock cycles between receiving the update and storing the update into the array, the update unit compares the current functional input address to the update address. If the current functional input address matches the update address, then the update value is provided as the output of the array. Otherwise, the information stored in the indexed storage location is provided. In this manner, the update appears to have been performed in the clock cycle that the update value was received, as in the dual-ported array. However, the second port has been advantageously removed. A large amount of silicon area may be saved.

A particular embodiment of the update unit is a branch prediction array update unit. This embodiment collects the update prediction information for each misprediction or external fetch. When a fetch address is presented for branch prediction, the fetch address is compared to the update address stored in the update unit. If the addresses match, then the update prediction information is forwarded as the output of the array. If the addresses do not match, then the information stored in the indexed storage location is forwarded as the output of the array. When the next external fetch begins or misprediction is detected, the update is written into the branch prediction array.

This embodiment allows a microprocessor to update branch prediction information speculatively in order to, among other things, predict the size of the memory required for the data being transferred. This functionality is desirable because modern microprocessors allow out-of-order execution of instructions, including branch instructions. Out-of-order instructions are generally executed speculatively, meaning that the instruction execution is not known to be needed by the sequential execution of the program. An instruction may be executed speculatively, for example, if it is on the path that is the target of a predicted branch instruction which has not yet executed. An instruction becomes nonspeculative when each instruction previous to it is guaranteed to execute, and therefore that instruction is guaranteed to execute. If updates were written directly into the array, then speculatively updating the branch prediction information would skew the information with incorrect data. Correct prediction rates might suffer. However, by placing the update information in the update unit, a speculative update may occur. If the next branch misprediction is for a branch instruction that is prior to the branch instruction associated with the current update information, the current update information is discarded instead of being written into the branch prediction array. Performance may be increased by advantageously updating branch prediction information speculatively but being able to discard the information if the branch is not to be executed.

Broadly speaking, the present invention contemplates an update unit for providing a delayed update to an array on an integrated circuit, comprising an update storage device, an input selection device, an output selection device, and a functional array input bus. The update storage device stores update information for the array and is coupled to a write input port of the array. The input selection device selects an input to the array. The update storage device is coupled to the input selection device, which is coupled to an input port of the array. Also coupled to the input selection device is the functional array input bus which conveys a non-update input value to the array. Coupled to the output port of the array and the update storage device, the output selection device is configured to select between the output port of the array and the update storage device to convey a value as the output of the array.

The present invention further contemplates a method for delayed update of an array on an integrated circuit. The method comprises storing update information in a storage device and updating the array during a clock cycle in which a functional input to the array is idle. The present invention still further contemplates an update unit for a branch prediction array comprising four components. The first component is a register for storing branch prediction update information which is coupled to an input multiplexor as a first input. An address bus for conveying a current fetch address to the branch prediction array is the second component, and address bus is coupled to the input multiplexor as a second input. Third is the input multiplexor for selectively coupling the address bus and the register to an input to the array. The fourth component is an output multiplexor coupled to an output port of the array and to the register. The output multiplexor is configured to select between the output port of the array and the register to convey a value as the output of the array.

Another embodiment of the present invention includes a microprocessor that includes an instruction fetch unit with simultaneous prediction of multiple control-flow instructions. The instruction fetch unit fetches a group of N instructions, called the current fetch bundle, each instruction fetch cycle. For the purposes of this disclosure, an “instruction fetch cycle” refers to a clock cycle or cycles in which instructions are fetched from cache or memory for dispatch into the instruction processing pipeline. The current fetch bundle includes the instruction located at a current fetch bundle address and the N-1 subsequent instructions in sequential order. For each current fetch bundle, the instruction fetch unit generates one or more predicted branch target addresses, a sequential address, a return address, and, if a misprediction is detected, a corrected branch target address. Based upon the detection of a branch misprediction and/or the occurrence of control-flow instructions within the current fetch bundle, branch logic selects one of the above addresses as the next fetch bundle address.

If a branch misprediction is detected, the corrected branch target address is selected as the next fetch bundle address. If no branch misprediction is detected, the control-flow instructions with the current fetch bundle are identified. If the first “taken” control-flow instruction is a return from a call instruction, the return address is selected as the next fetch bundle address. For the purposes of the disclosure, a “taken control-flow instruction” may be an unconditional control-flow instruction, such as a unconditional branch or return instruction, or a conditional branch instruction that is predicted “taken”. If the first control-flow instruction is an unconditional branch, one of the predicted branch target addresses is selected as the next fetch bundle address. If the first control-flow instruction is a conditional branch instruction that is predicted taken, one of the predicted branch addresses is selected as the next fetch bundle address. If no “taken control-flow instructions” are within a fetch bundle, the sequential address is selected as the next fetch bundle address. The sequential address is the address of the fetch bundle that is numerically sequential to the current fetch bundle. If a fetch bundle includes eight instructions, the sequential address is the current fetch bundle address plus the number of addresses occupied by the eight instructions. For example, if instructions are byte addressable and each instruction is thirty-two bits, the sequential address is the current fetch bundle address plus thirty-two.

Multiple predicted branch target addresses may be derived per fetch bundle. Accordingly, different control-flow instructions within a fetch bundle may have different predicted branch target addresses. An instruction fetch mechanism in accordance with the present invention advantageously permits the simultaneous prediction of multiple control-flow instructions, including multiple types of control-flow instructions, each instruction fetch cycle.

Generally speaking, the present invention contemplates an instruction fetch unit that concurrently makes multiple predictions for different types of control-flow instructions including a branch address table, a sequential address circuit, an unresolved branch circuit, a multiplexer and a branch logic circuit. The branch address table is configured to store predicted branch target addresses for branch instructions and to output a predicted branch target address signal. The sequential address circuit is configured to calculate a sequential address and to output a sequential fetch address signal. The unresolved branch circuit is configured to store a corrected branch target address for a mispredicted branch instruction and to output a corrected branch target address signal. The multiplexer is coupled to receive a plurality of input signals including the predicted branch target address signal, the sequential fetch address signal and the corrected branch target address signal, and configured to output a current fetch bundle address signal that addresses a fetch bundle. The branch logic circuit is coupled to a control signal of the multiplexer. The branch logic circuit is configured to cause the multiplexer to select one of the plurality of input signals in dependence on an occurrence of a control-flow instruction within the fetch bundle or an occurrence of a mispredicted branch instruction.

The present invention further contemplates a method for concurrently making multiple predictions of different types of control-flow instructions including: generating a sequential fetch address, wherein the sequential fetch address is an address of a fetch bundle sequential in numerical order to a current fetch bundle; generating a predicted branch target address; generating a corrected branch target address, wherein the corrected branch target address is the correct target address of mispredicted branch instruction; detecting a branch misprediction, wherein if a branch misprediction is detected, the corrected branch target address is selected as a next fetch bundle address; and detecting a first taken control-flow instruction. If the first taken control-flow instruction is an unconditional branch instruction, the predicted branch target address is selected as the next fetch bundle address. If the first taken control-flow instruction is a taken conditional branch instruction, the predicted branch target address is selected as the next fetch bundle address. If neither a branch misprediction or a taken control-flow instruction is detected, the sequential fetch address is selected as the next fetch bundle address. A next fetch bundle is retrieved using the next fetch bundle address.

In order to increase performance, microprocessors may employ prefetching to “guess” which data will be requested in the future by the program being executed. The term prefetch, as used in this section, refers to transferring data into a microprocessor (or cache memory attached to the microprocessor) prior to a request for the data being generated via execution of an instruction within the microprocessor. Generally, prefetch algorithms (i.e. the methods used to generate prefetch addresses) are based upon the pattern of accesses which have been performed in response to the program being executed. For example, one data prefetch algorithm is the stride-based prefetch algorithm in which the difference between the addresses of consecutive accesses (the “stride”) is added to subsequent access addresses to generate a prefetch address. Another type of prefetch algorithm is the stream prefetch algorithm in which consecutive data words (i.e. data words which are contiguous to one another) are fetched.

The type of prefetch algorithm which is most effective for a given set of instructions within a program depends upon the type of memory access pattern exhibited by the set of instructions (or instruction stream). Stride-based prefetch algorithms often work well with regular memory reference patterns (i.e. references separated in memory by a fixed finite amount). An array, for example, may be traversed by reading memory locations which are separated from each other by a regular interval. After just a few memory fetches, the stride-based prefetch algorithm may have learned the regular interval and may correctly predict subsequent memory fetches. On the other hand, the stream prefetch algorithm may work well with memory access patterns in which a set of contiguous data is accessed once and then not returned to for a relatively long period of time. For example, searching a string for a particular character or for comparing to another string may exhibit a stream reference pattern. If the stream can be identified, the data can be prefetched, used once, and discarded. Yet another type of reference pattern is a loop reference pattern, in which data may be accessed a fixed number of times (i.e. the number of times the loop is executed) and then may not be accessed for a relatively long period of time.

None of the prefetch algorithms described above is most effective for all memory access patterns. In order to maximize prefetching and caching efficiency, it is therefore desirable to identify early in a microprocessor pipeline which type of memory access pattern is to be performed by an instruction stream being fetched in order to employ the appropriate prefetch algorithm for that instruction stream. The earlier in the pipeline that the prefetch algorithm may be determined, the earlier the prefetch may be initiated and consequently the lower the effective latency of the accessed data may be.

In accordance with the present invention, a prefetch unit can be used. The prefetch unit stores a plurality of prefetch control fields in a data history table. Each prefetch control field selects one of multiple prefetch algorithms for use in prefetching data. As an instruction stream is fetched, the fetch address is provided to the data history table for selecting a prefetch control field. Advantageously, an appropriate prefetch algorithm for the instruction stream being fetched may be selected. Since multiple prefetch algorithms are supported, many different data reference patterns may be successfully prefetched. Different parts of a particular program may exhibit different data reference patterns, and an appropriate prefetch algorithm for each of the reference patterns may be initiated upon execution of the different parts of the program. Effective latency for data accesses may be reduced if the prefetch algorithm successfully prefetches memory operands used by the corresponding instruction stream.

The prefetch unit is configured to gauge the effectiveness of the selected prefetch algorithm, and to select a different prefetch algorithm if the selected prefetch algorithm is found to be ineffective. The prefetch unit monitors the load/store memory operations performed in response to the instruction stream (i.e. the non-prefetch memory operations) to determine the effectiveness. Alternatively, the prefetch unit may evaluate each of the prefetch algorithms with respect to the observed set of memory references and select the algorithm which is most accurate.

Broadly speaking, the present invention contemplates a prefetch unit comprising a data history table coupled to a control unit. Coupled to receive a fetch address, the data history table is configured to store a plurality of data address predictions. Each of the plurality of data address predictions includes a prefetch control field identifying one of a plurality of prefetch algorithms. In response to the fetch address, the data history table is configured to select one of the plurality of data address predictions. Coupled to the data history table, the control unit is configured to initiate the one of the plurality of prefetch algorithms indicated by the prefetch control field within the one of the plurality of data address predictions.

The present invention further contemplates a microprocessor comprising an instruction cache and a prefetch unit. The instruction cache is configured to provide a plurality of instructions for execution in response to a fetch address. Coupled to receive the fetch address concurrent with the instruction cache, the prefetch unit includes a data history table configured to provide a data address prediction in response to the fetch address. The data address prediction includes a prefetch control field, and the prefetch unit is configured to select one of a plurality of prefetch algorithms in response to the prefetch control field. Furthermore, the prefetch unit is configured to initiate prefetching using the one of the plurality of prefetch algorithms.

Moreover, the present invention contemplates a method for prefetching comprising. A plurality of instructions are fetched from an instruction cache. A data history table is accessed to select a selected prefetch algorithm from a plurality of prefetch algorithms using a prefetch control field corresponding to the plurality of instructions. Data is prefetched for use by the plurality of instructions using the selected prefetch algorithm.

Superscalar microprocessors are capable of attaining performance characteristics which surpass those of conventional scalar processors by allowing the concurrent execution of multiple instructions. Due to the widespread acceptance of the x86 family of microprocessors, efforts have been undertaken by microprocessor manufacturers to develop superscalar microprocessors which execute x86 instructions. Such superscalar microprocessors achieve relatively high performance characteristics while advantageously maintaining backwards compatibility with the vast amount of existing software developed for previous microprocessor generations such as the 8086, 80286, 80386, and 80486.

The x86 instruction set is relatively complex and is characterized by a plurality of variable byte length instructions. An x86 instruction consists of from one to five optional prefix bytes, followed by an operation code (opcode) field, an optional addressing mode (Mod R/M) byte, an optional scale-index-base (SIB) byte, an optional displacement field, and an optional immediate data field.

The opcode field defines the basic operation for a particular instruction. The default operation of a particular opcode may be modified by one or more prefix bytes.

For example, a prefix byte may be used to change the address or operand size for an instruction, to override the default segment used in memory addressing, or to instruct the processor to repeat a string operation a number of times. The opcode field follows the prefix bytes, if any, and may be one or two bytes in length. The addressing mode (Mod R/M) byte specifies the registers used as well as memory addressing modes. The scale-index-base (SIB) byte is used only in 32-bit base-relative addressing using scale and index factors. A base field of the SIB byte specifies which register contains the base value for the address calculation, and an index field specifies which register contains the index value. A scale field specifies the power of two by which the index value will be multiplied before being added, along with any displacement, to the base value. The next instruction field is the optional displacement field, which may be from one to four bytes in length. The displacement field contains a constant used in address calculations. The optional immediate field, which may also be from one to four bytes in length, contains a constant used as an instruction operand. The shortest x86 instructions are only one byte long, and comprise a single opcode byte. The 80286 sets a maximum length for an instruction at 10 bytes, while the 80386 and 80486 both allow instruction lengths of up to 15 bytes.

The complexity of the x86 instruction set poses many difficulties in implementing high performance x86 compatible superscalar microprocessors. One difficulty arises from the fact that instructions must be scanned and aligned before proper decode can be effectuated by the parallel-coupled instruction decoders used in such processors. In contrast to most RISC instruction formats, since the x86 instruction set consists of variable byte length instructions, the start bytes of successive instructions within a line are not necessarily equally spaced, and the number of instructions per line is not fixed. As a result, employment of simple, fixed-length shifting logic cannot by itself solve the problem of instruction alignment.

Instead of simple shifting logic, x86 compatible microprocessors typically use instruction scanning mechanisms to generate start and end bits for each instruction byte as they are stored in the instruction cache. These start and end bits are then used to generate a valid mask for each instruction. A valid mask is a series of bits in which each consecutive bit corresponds to a particular byte of instruction information. For a particular instruction fetch, the valid mask bits associated with the first byte of the instruction, the last byte of the instruction, and all bytes in between the first and last bytes of the instruction are asserted. All other bits in the valid mask are not asserted. For example, given the following 8-byte instruction cache line, the following valid mask would be generated for a fetch of instruction B:

| | | | | | | | | |
|---|---|---|---|---|---|---|---|---|
| byte .fwdarw. | 0 | 1 | 2 | 3 | 4 | 5 | 6 | 7 |
| cache line | A | A | B | B | B | B | C | C |
| bit .fwdarw. | 0 | 1 | 2 | 3 | 4 | 5 | 6 | 7 |
| end bit information | 0 | 1 | 0 | 0 | 0 | 1 | 0 | 0 |
| start bits | 0 | 0 | 1 | 0 | 0 | 0 | 1 | 0 |
| valid mask | 0 | 0 | 1 | 1 | 1 | 1 | 0 | 0 |

Once a valid mask is calculated for a particular instruction fetch, it may then be used to mask off the unwanted bytes that are not part of the particular instruction. In the example above, the valid mask for the fetch of instruction B could be used to mask off the unwanted end bytes of instruction A and the unwanted beginning bytes of instruction C. This masking is typically performed in an instruction alignment unit.

An embodiment of the present invention utilizes an instruction cache having a pattern detector to provide information used to calculate the amount of memory required to transfer the data. The instruction cache is configured to predict the length of variable length instructions based upon previous instruction length history. The instruction cache comprises an instruction length calculation unit and a pattern detector. The pattern detector comprises a memory structure and update logic.

In one embodiment, the memory structure is a content addressable memory that stores fetch addresses and instruction length sequences. The content addressable memory is configured to compare requested fetch addresses with stored fetch addresses. If there is a match, the content addressable memory is configured to output a corresponding instruction length sequence. If there is not a match, the update logic is configured to store the fetch address into the content addressable memory along with a corresponding instruction length sequence. The instruction length sequence comprises a predetermined number of instruction lengths calculated by the calculation unit.

In another embodiment, the content addressable memory may receive, compare, and store instruction bytes in addition to, or in lieu of, fetch addresses. A neural network or other type of memory configuration may be used in place of the content addressable memory.

A microprocessor using the instruction cache is also contemplated. One embodiment of the microprocessor comprises a cache array, an instruction length calculation unit, and a pattern generator. The cache array is configured to receive a fetch address and in response output a corresponding plurality of instruction bytes. The calculation unit is coupled to the cache array and is configured to receive the plurality of instruction bytes. The calculation unit is configured to generate instruction lengths corresponding to particular instructions within the plurality of instruction bytes. The pattern detector is coupled to the cache array and calculation unit. The pattern detector is configured to store a plurality of fetch addresses and instruction length sequences. Each stored sequence corresponds to a particular stored fetch address. The pattern detector is further configured to output a particular stored sequence of instruction lengths in response to receiving a corresponding fetch address as input.

A method for predicting instruction lengths for variable length instructions is also contemplated. The method comprises reading a plurality of instruction bytes from a cache by using a fetch address and generating instruction lengths for instructions within the plurality of instruction bytes. The fetch addresses and instruction lengths are stored. Each particular fetch address is compared with the stored fetch addresses, and a plurality of predicted instruction lengths are generated by selecting a stored instruction length sequence corresponding to the fetch address being compared. Finally, the predicted sequence of instruction lengths is verified.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for data transfer across different clock domains, comprising the steps of:
(a) receiving a request for transferring data from a sending process in a first domain to a receiving process in a second domain, wherein the first domain and the second domain have different clocks;
(b) creating a channel circuit with handshaking and resynchronization logic for helping resolve metastability; and
(c) utilizing the channel circuit for transferring the data from the sending process to the receiving process.

2. A method as recited in claim 1, wherein multiple sending processes send data along the same channel circuit.

3. A method as recited in claim 1, wherein multiple receiving processes receive data along the same channel circuit.

4. A method as recited in claim 1, wherein the channel circuit is built with four-phase handshaking.

5. A method as recited in claim 1, wherein the data of the sending process is assigned to a variable of the receiving process.

6. A method as recited in claim 1, wherein the channel circuit includes a controller and a data path, wherein the controller instructs the data path when to store a variable in a storage medium associated with the receiving process being sent by the sending process.

7. A computer program product for data transfer across different clock domains, comprising:
(a) computer code for receiving a request for transferring data from a sending process in a first domain to a receiving process in a second domain, wherein the first domain and the second domain have different clocks;
(b) computer code for creating a channel circuit with handshaking and resynchronization logic for helping resolve metastability; and
(c) computer code for utilizing the channel circuit for transferring the data from the sending process to the receiving process.

8. A computer program product as recited in claim 7, wherein multiple sending processes send data along the same channel circuit.

9. A computer program product as recited in claim 7, wherein multiple receiving processes receive data along the same channel circuit.

10. A computer program product as recited in claim 7, wherein the channel circuit is built with four-phase handshaking.

11. A computer program product as recited in claim 7, wherein the data of the sending process is assigned to a variable of the receiving process.

12. A computer program product as recited in claim 7, wherein the channel circuit includes a controller and a data path, wherein the controller instructs the data path when to store a variable in a storage medium associated with the receiving process being sent by the sending process.

13. A system for data transfer across different clock domains, comprising:
(a) logic for receiving a request for transferring data from a sending process in a first domain to a receiving process in a second domain, wherein the first domain and the second domain have different clocks;
(b) logic for creating a channel circuit with handshaking and resynchronization logic for helping resolve metastability; and
(c) logic for utilizing the channel circuit for transferring the data from the sending process to the receiving process.

14. A system as recited in claim 13, wherein multiple sending processes send data along the same channel circuit.

15. A system as recited in claim 13, wherein multiple receiving processes receive data along the same channel circuit.

16. A system as recited in claim 13, wherein the channel circuit is built with four-phase handshaking.

17. A system as recited in claim 13, wherein the data of the sending process is assigned to a variable of the receiving process.

18. A system as recited in claim 13, wherein the channel circuit includes a controller and a data path, wherein the controller instructs the data path when to store a variable in a storage medium associated with the receiving process being sent by the sending process.
